(19) United States
(12) Patent Application Publication
(10) Pub. No.: US 2016/0231424 A1
(43) Pub. Date: Aug. 11, 2016

(54) LASER DISTANCE MEASURE

(71) Applicants: Nen-Tsua Li, Taichung City (TW); Chen-Yu Liao, Taichung (TW)

(72) Inventors: Nen-Tsua Li, Taichung City (TW); Chen-Yu Liao, Taichung (TW)

(21) Appl. No.: 14/617,944

(22) Filed: Feb. 10, 2015

(51) Int. Cl. G01S 17/32; G01S 7/481

(52) U.S. Cl. CPC G01S 17/32; G01S 7/4813

(57) ABSTRACT

A laser distance measure includes a box with an emitting path and a receiving path defined therein. The receiving path is a tubular path and has a reflection wall therein. A light emitting unit is located in the emitting path and emits a first beam out from the box via the emitting path. The first beam is bounced back when hitting an object and enters into the receiving path to form a second beam which passes through the receiving path and is received by a light receiver in the receiving path. The first beam is bounced back and reflected by the reflection wall so as to be successfully received by the light receiver so as to measure a short distance.

### BACKGROUND OF THE INVENTION

1. Fields of the Invention

The present invention relates to a distance measure, and more particularly, to a laser distance measure which uses laser beam to measure distance.

2. Descriptions of Related Art

The conventional way to measure a distance between two points is to use a tape measure, however, the tape measure is not suitable for measure a longer distance.

A laser distance measure is developed which emits a laser beam which bounces back when hit the object and the return laser beam is received by the laser distance measure. The laser distance measure transforms the information that the time required to receive the laser beam into digits to show the distance to the users. The laser distance measure is suitable for measuring a long distance because the return laser beam is parallel to the emitting laser beam so that the laser distance measure can successfully receive the return laser beam. However, when the distance is short, the return laser beam enters the laser distance measure at angle, the return laser beam reflects at least one time before being received by the light receiver in the laser distance measure. The return laser beam may not be able to reach the light receiver in the laser distance measure if the distance measured is too short. Therefore, the laser distance measure fails to provide the distance to the users. Some of the laser distance measures add a lens to increase the possibility that the return laser beam can be received by the light receiver. Nevertheless, this involves problems of high cost and complicated structure.

The present invention intends to provide a laser distance measure to eliminate the shortcomings mentioned above.

### SUMMARY OF THE INVENTION

The present invention relates to a laser distance measure and comprises a box with an emitting path and a receiving path defined therein. The receiving path is a tubular path and has a reflection wall therein. A light emitting unit is located in the emitting path and emits a first beam out from the box via the emitting path. The first beam is bounced back when hitting an object and enters into the receiving path to form a second beam which passes through the receiving path and is received by a light receiver in the receiving path.

Preferably, the light emitting unit has a circuit board and a laser chip which is electrically connected to the circuit board. The first beam is emitted by the laser chip.

Preferably, the box has a control unit connected thereto. The control unit is electrically connected to the light emitting unit to control the operation of the laser chip of the light emitting unit.

Preferably, the light receiver defines a first normal line and the reflection wall defines a second normal ling which is perpendicular to the first normal line.

Preferably, the light receiver defines a first normal line and the reflection wall defines a second normal ling. The angle between the first and second normal lines is larger than 90 degrees.

Preferably, the reflection wall is a planar surface or curved surface.

The primary object of the present invention is to provide a laser distance measure which is able to measure both of long and short distances.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the operation of the laser distance measure of the present invention to measure a long distance;

FIG. 2 shows that the laser distance measure of the present invention measures a short distance;

FIG. 3 shows the first and second normal lines of the laser distance measure of the present invention;

FIG. 4 shows the operation of the second embodiment of the laser distance measure of the present invention to measure a long distance;

FIG. 5 shows that the laser distance measure in FIG. 4 measures a short distance;

FIG. 6 shows the first and second normal lines of the laser distance measure of the present invention in FIG. 4;

FIG. 7 shows that the reflection wall of the laser distance measure of the present invention is a planar surface, and

FIG. 8 shows that the reflection wall of the laser distance measure of the present invention is a curved surface.

### DETAILED DESCRIPTION OF THE PREFERRED EMBODIMENT

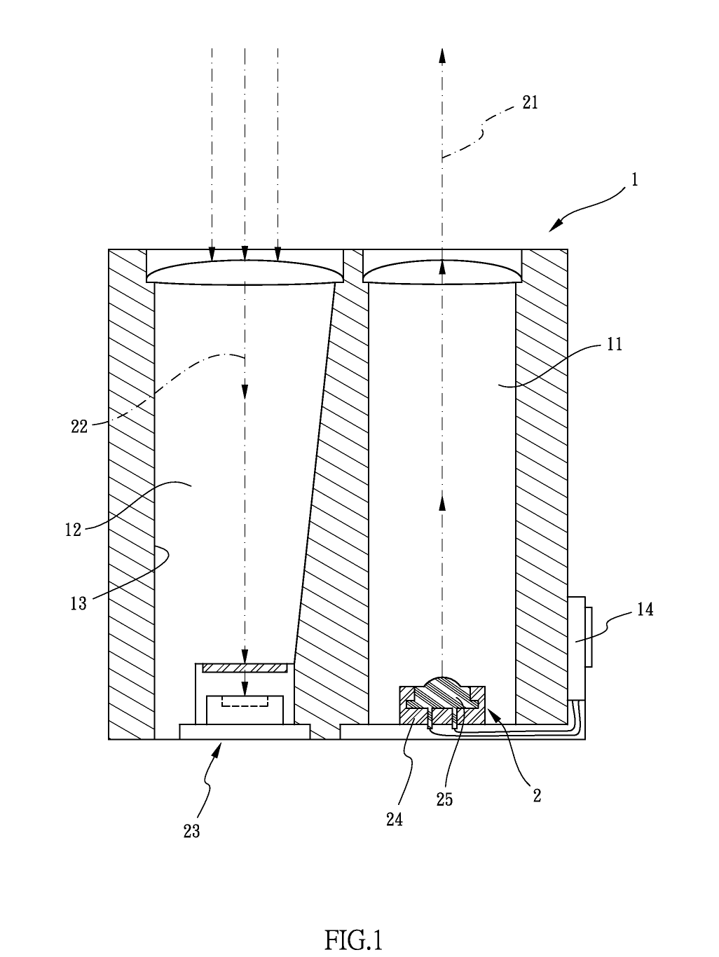

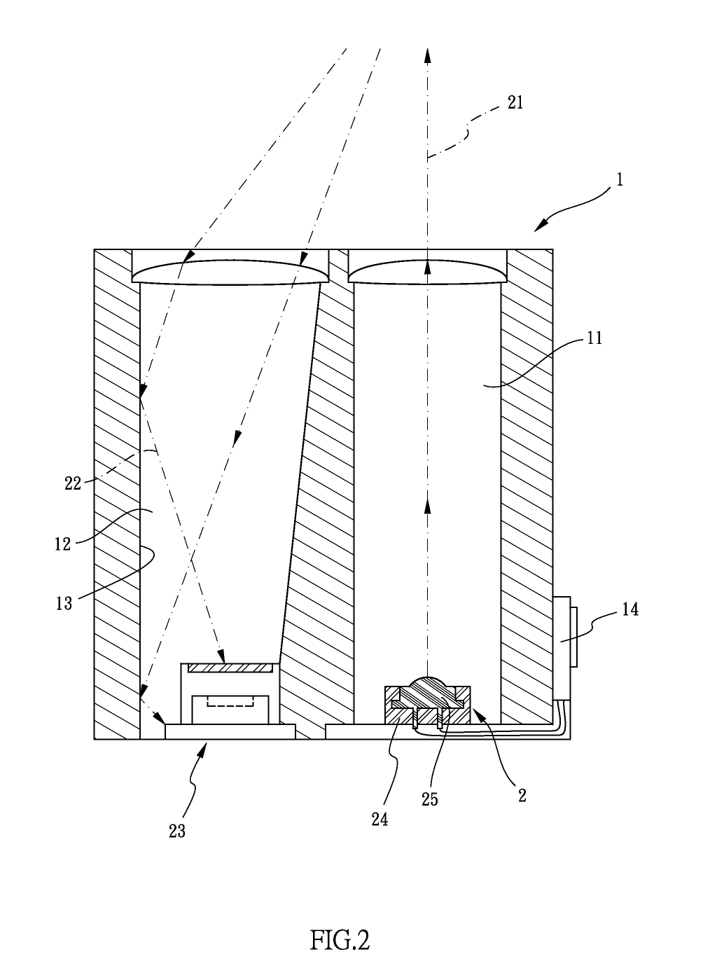

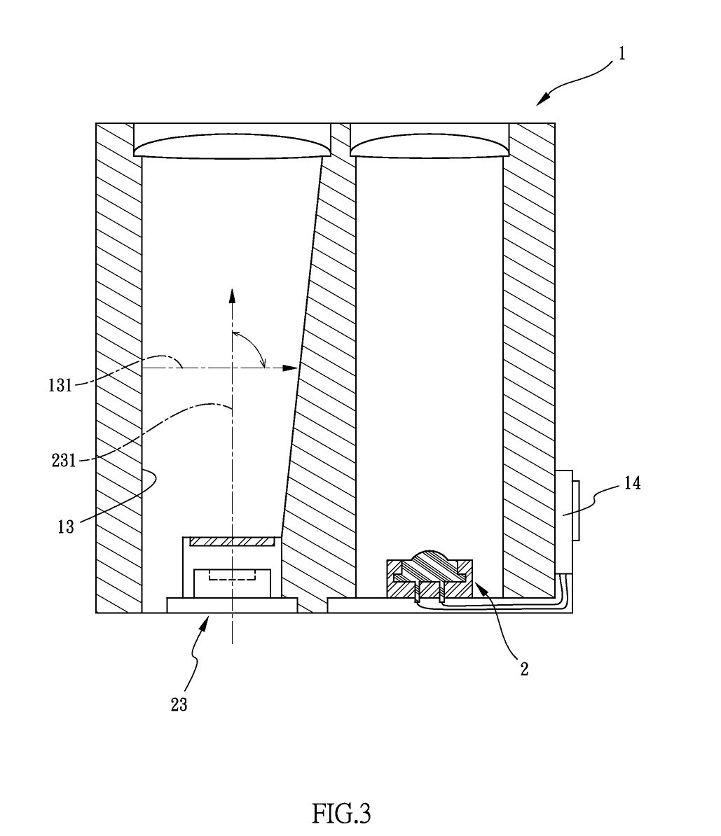

Referring to FIGS. 1 to 3, the laser distance measure of the present invention comprises a box 1 and a light emitting unit 2 in the box 1. The box 1 has an emitting path 11 and a receiving path 12 defined therein. The receiving path 12 is a tubular path and has a reflection wall 13. The light emitting unit 2 is located in the emitting path 11 and able to emit a first beam 21 out from the box 1 via the emitting path 11. The first beam 21 is then bounced back when hitting an object and enters into the receiving path 12 to form a second beam 22 passing through the receiving path 12. The second beam 22 is received by a light receiver 23 in the receiving path 12.

When measuring a long distance, the light emitting unit 2 emits the first beam 21 out from the box 1 via the emitting path 11. The first beam 21 is bounced back when hitting the target object. The first beam 21 disperses and enters into the receiving path 12 to form the second beam 22 passing through the receiving path 12. The second beam 22 is received by the light receiver 23 in the receiving path 12. The information of the receiving of the second beam 22 is then transformed into digits of the distance between the box 1 and the target object.

When measuring a short distance, the light emitting unit 2 emits the first beam 21 out from the box 1 via the emitting path 11. The first beam 21 is bounced back when hitting the target object. The first beam 21 enters into the receiving path 12 to form the second beam 22 passing through the receiving path 12. Because the distance is short, so that the second beam 22 cannot directly reach the light receiver 23, the second beam 22 is reflected by the reflection wall 13 and then received by the light receiver 23 in the receiving path 12. The information of the receiving of the second beam 22 is then transformed into digits of the distance between the box 1 and the target object.

Furthermore, the light emitting unit 2 has a circuit board 24 and a laser chip 25 which is electrically connected to the circuit board 24. The first beam 21 is emitted by the laser chip 25. Besides, the box 1 has a control unit 14 connected thereto. The control unit 14 is electrically connected to the light emitting unit 2 to control the operation of the laser chip 25 of the light emitting unit 2. By operating the control unit 14, the users can set a desired emitting way according individual task needs.

The light receiver 23 defines a first normal line 231 and the reflection wall 13 defines a second normal ling 131 which is perpendicular to the first normal line 231. By the arrangement, the bounced first beam 21 can be reflected and received by the light receiver 23. In other words, a short distance can also be measured by the present invention because the reflection wall 13 reflects the bounced first beam 21 to form the second beam 22 in the receiving path 12.

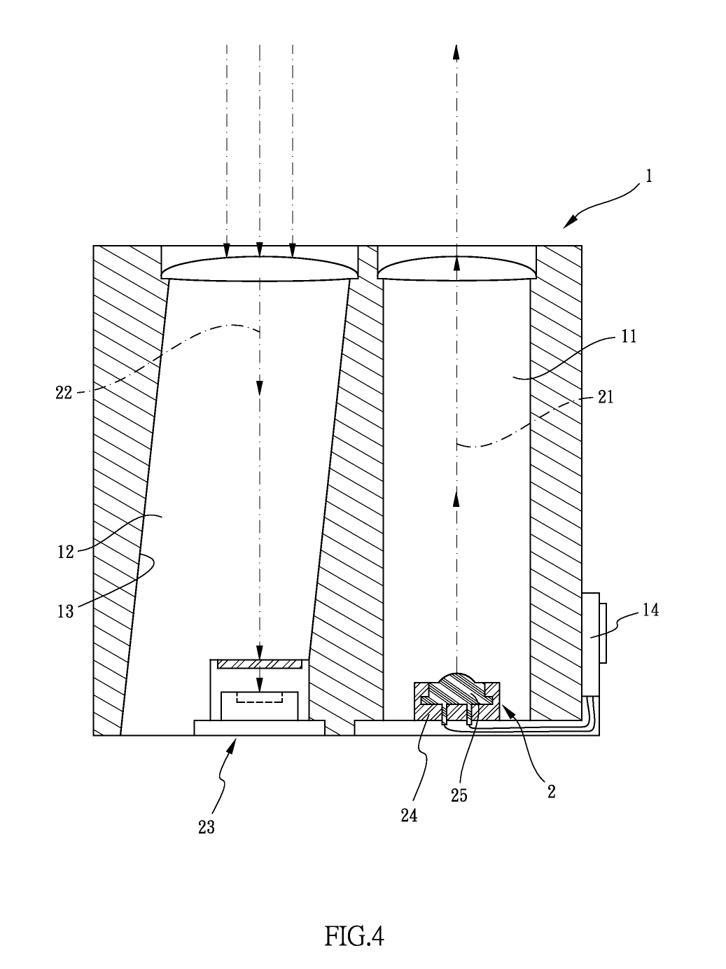

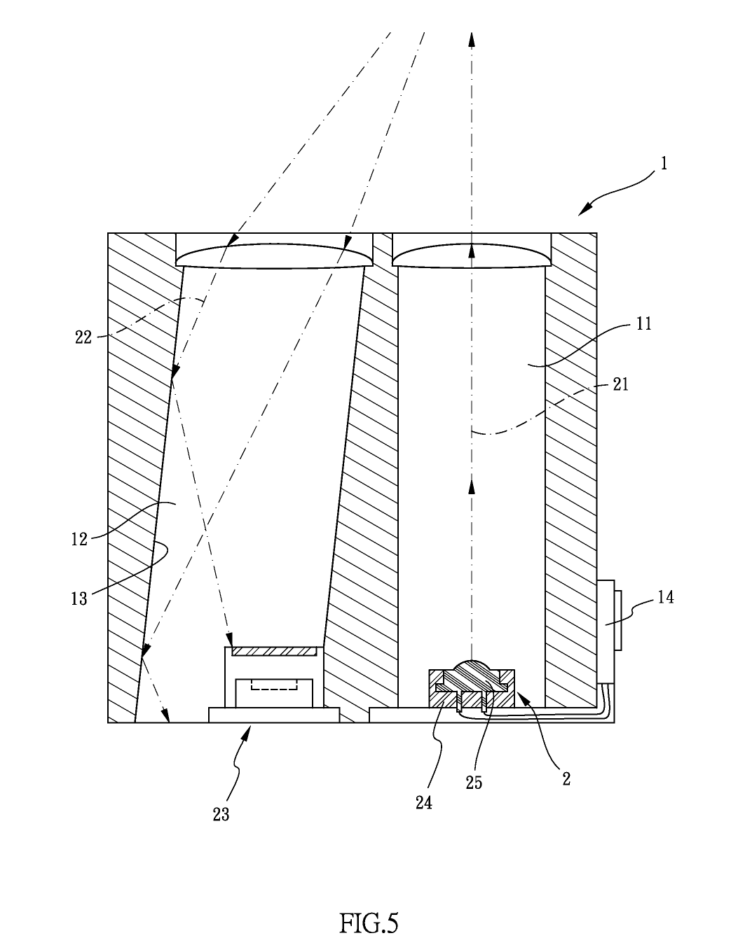

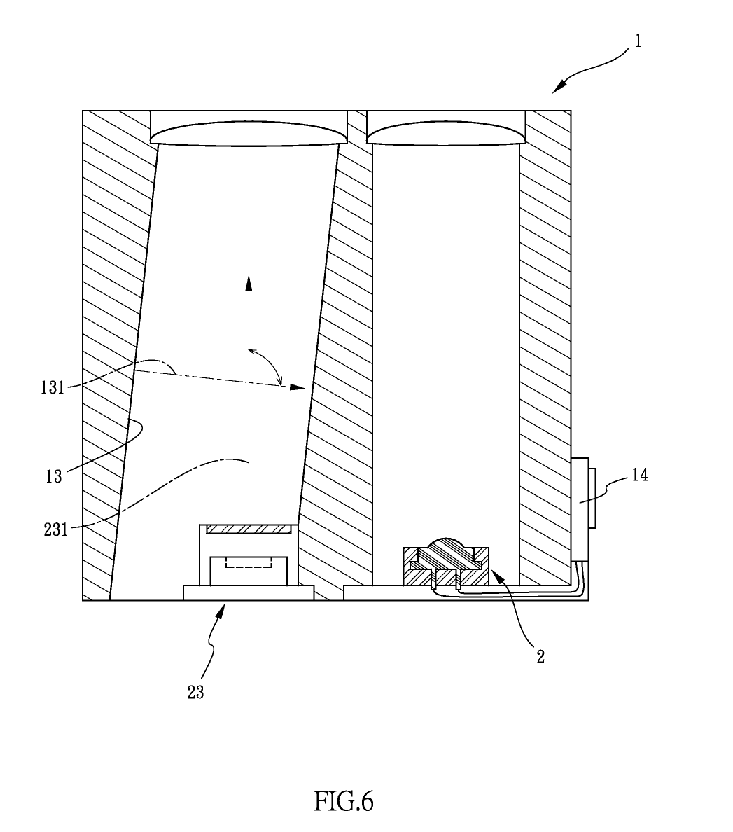

As shown in FIGS. 4 to 6, a second embodiment is disclosed wherein the difference from the first embodiment is that the light receiver 23 defines a first normal line 231 and the reflection wall 13 defines a second normal ling 131, wherein the angle between the first and second normal lines 231, 131 is larger than 90 degrees. When measuring a long distance, the operation and steps are the same as those of the first embodiment. When measuring a short distance, the different inclination of the reflection wall 13 can successfully reflect the bounced first beam 21 to form the second beam 22 in the receiving path 12.

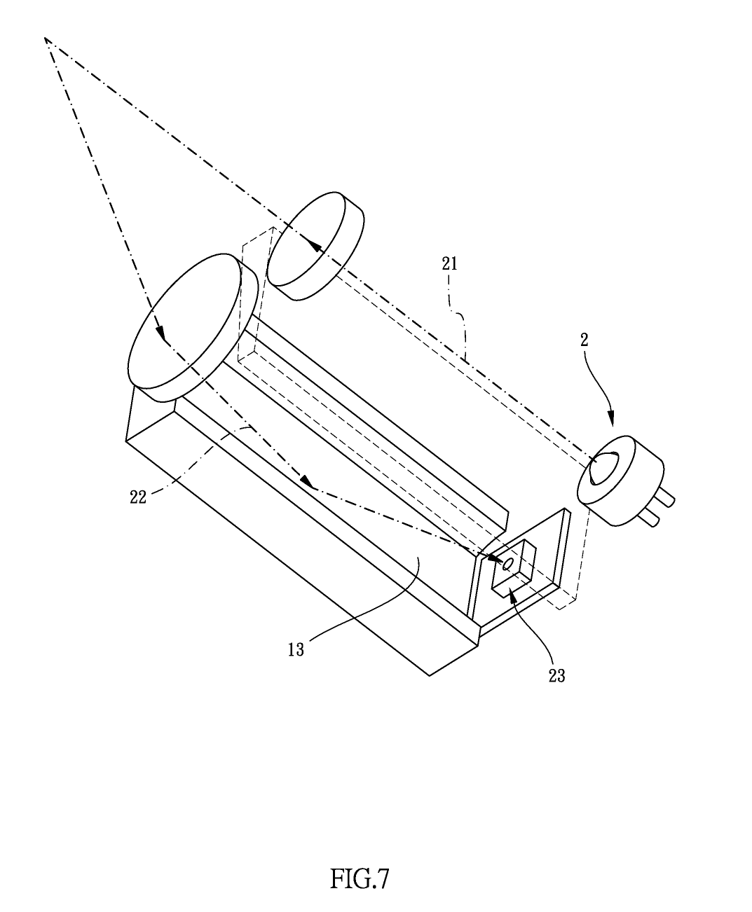

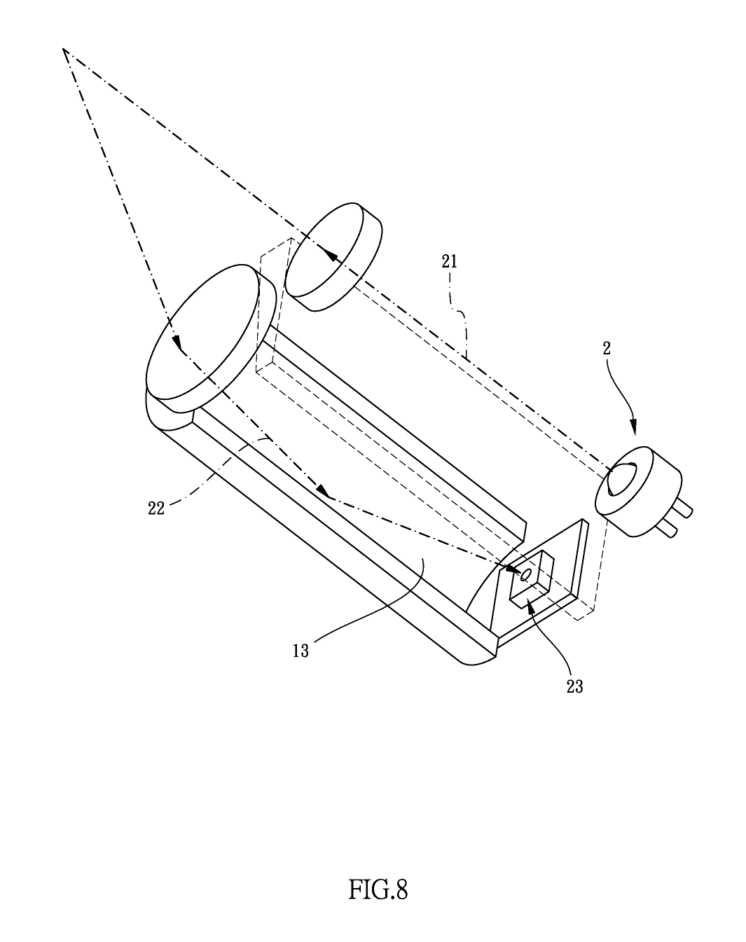

As shown in FIGS. 7 and 8, in order to ensure that the second beam 22 can be received by the light receiver 23, the reflection wall 13 is a planar surface or curved surface.

While we have shown and described the embodiment in accordance with the present invention, it should be clear to those skilled in the art that further embodiments may be made without departing from the scope of the present invention.

What is claimed is:

1. A laser distance measure comprising:
a box having an emitting path and a receiving path defined therein, the receiving path being a tubular path and having a reflection wall, and
a light emitting unit located in the emitting path and emitting a first beam, the first beam emitting out from the box via the emitting path, the first beam being bounced back and entering into the receiving path to form a second beam passing through the receiving path, the second beam being received by a light receiver which is located in the receiving path.

2. The laser distance measure as claimed in claim 1, wherein the light emitting unit has a circuit board and a laser chip which is electrically connected to the circuit board, the first beam is emitted by the laser chip.

3. The laser distance measure as claimed in claim 2, wherein the box has a control unit connected thereto, the control unit is electrically connected to the light emitting unit to control an operation of the laser chip of the light emitting unit.

4. The laser distance measure as claimed in claim 3, wherein the light receiver defines a first normal line and the reflection wall defines a second normal ling which is perpendicular to the first normal line.

5. The laser distance measure as claimed in claim 3, wherein the light receiver defines a first normal line and the reflection wall defines a second normal ling, an angle between the first and second normal lines is larger than 90 degrees.

6. The laser distance measure as claimed in claim 1, wherein the reflection wall is a planar surface or curved surface.
